(19) United States
(12) Patent Application Publication
(10) Pub. No.: US 2025/0322259 A1
(43) Pub. Date: Oct. 16, 2025

(54) System And Method For Dynamic Hyperparameter Optimization For Large Language Models Using (Few-Shot) Reinforcement Learning

(71) Applicant: Oracle International Corporation, Redwood Shores, CA (US)

(72) Inventors: Iman Zadeh, Los Angeles, CA (US); Jun Qian, Bellevue, WA (US)

(73) Assignee: Oracle International Corporation, Redwood Shores, CA (US)

(21) Appl. No.: 18/635,391

(22) Filed: Apr. 15, 2024

(51) Int. Cl. G06N 3/0985; G06N 3/0455; G06N 3/092

(52) U.S. Cl. CPC G06N 3/0985; G06N 3/0455; G06N 3/092

(57) ABSTRACT

Techniques for increasing the quality of output from large language models using reinforcement learning to select inference-time hyperparameters are disclosed. The large language model is configured with a set of values corresponding to a set of inference-time hyperparameters that are used to influence the output of the machine learning model after the model has been frozen. After obtaining a set of performance metrics that indicate the quality of the output, a reinforcement learning agent computes an adjustment for one or more of the hyperparameters, resulting in a modification of the hyperparameter values. Applying the new hyperparameter values, the large language model is then applied to a new set of input to generate a second output. The process iterates until the performance metrics associated with the output are satisfactory.

### TECHNICAL FIELD

The present disclosure relates to large language models. In particular, the present disclosure relates to hyperparameter optimization for using large language models.

### BACKGROUND

Large language models (LLMs) are sophisticated machine learning constructs used for processing, understanding, and generating human language, leveraging the power of neural networks. These models are trained on vast collections of text snippets, allowing them to process and model the nuances and grammatical frameworks of multiple languages. Through unsupervised learning methods, LLMs predict subsequent words or tokens in sentences, enhancing their linguistic proficiency. This capability allows them to perform a myriad of natural language processing tasks, such as translation, summarization, and question answering, by understanding and generating text that aligns with the given context.

For large language models that have been trained and subsequently locked/frozen, hyperparameters may be used to modulate the model's output without altering its underlying architecture. Hyperparameters, such as temperature, top-k, and top-p sampling strategies allow operators to fine-tune the generated text's creativity, coherence, and relevance. Temperature controls the randomness in prediction, with lower values making the model's output more deterministic. Top-k limits the model's choice to the k most likely next words, reducing the probability of introducing irrelevant content. Similarly, top-p sampling, or nucleus sampling, narrows down the model's choices based on a cumulative probability distribution. This approach fine-tunes the relevance of the generated text to the input context by focusing on a select set of highly probable outcomes. These and many other hyperparameters allow operators to customize the model's output to specific needs, enhancing its utility across diverse applications without retraining the model.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 shows a block diagram of a machine learning engine in accordance with one or more embodiments;

FIG. 2 illustrates the operation of a machine learning engine in accordance with one or more embodiments;

FIG. 3 illustrates a system in accordance with one or more embodiments;

FIG. 4 shows a flow chart that illustrates generating a hyperparameter update recommendations in accordance with one or more embodiments;

FIG. 5 illustrates an example set of operations for tuning inference-time hyperparameters in accordance with one or more embodiments;

FIG. 6 shows a flow chart that illustrates an example embodiment; and

FIG. 7 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. MACHINE LEARNING ARCHITECTURE
3. LARGE LANGUAGE MODELS
4. HYPERPARAMETERS
5. INFERENCE-TIME HYPERPARAMETER TUNING ARCHITECTURE
6. TUNING HYPERPARAMETERS
7. EXAMPLE EMBODIMENT
8. EXTENSIONS AND ALTERNATIVES
9. COMPUTER NETWORKS AND CLOUD NETWORKS
10. HARDWARE OVERVIEW
11. MISCELLANEOUS

### 1. GENERAL OVERVIEW

One or more embodiments leverage reinforcement learning to assist with the selection of optimal inference-time hyperparameter values for a large language model. The hyperparameter values are iteratively updated and then used to configure a large language model during the inference phase. The large language model, for example, by applied to a set of operator input.

Initially, the large language model is trained. Once trained, the large language model is not changed or further trained. To fine-tune the output of the large language model, the large language model may be configured with a set of values corresponding to a set of inference-time hyperparameters that are used to influence the output of the machine learning model. These hyperparameters are applied after the model has been frozen without altering the model. One example of an inference-time hyperparameter is temperature. The temperature value influences a degree of exploration of less likely options as the large language model generates text.

After obtaining a set of performance metrics that indicate the quality of the output, a reinforcement learning agent employs techniques such as few-shot reinforcement learning. The reinforcement learning agent is initially trained across a set of tasks, and then uses a few examples to adjust its knowledge and fine-tune its strategy. The reinforcement learning agent computes an adjustment for one or more of the hyperparameter values, resulting in a modification of at least one of the hyperparameter values. The reinforcement learning agent applies the adjustment to the hyperparameter values. With new hyperparameter values in place, the large language model is then applied to a new set of input to generate output. The new output may then be assigned a quality score that can be used for further tuning of hyperparameter values. The process iterates until the performance metrics associated with the output are satisfactory, or other conditions are met.

One or more embodiments described in this Specification and/or recited in the claims may not be included in this General Overview section.

### 2. MACHINE LEARNING ARCHITECTURE

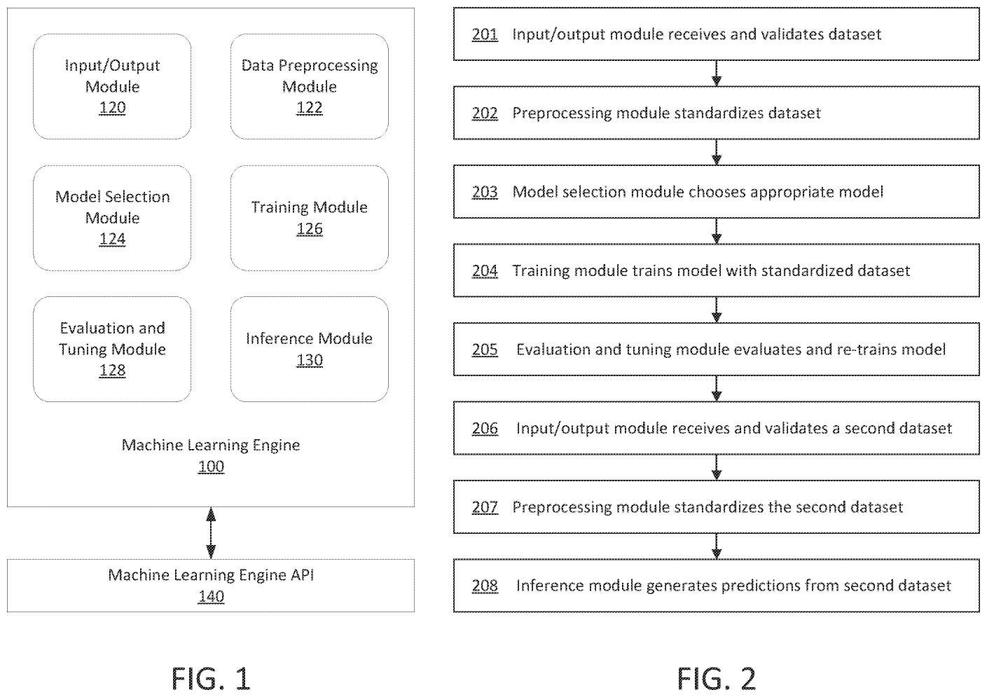

FIG. 1 illustrates a machine learning engine 100 in accordance with one or more embodiments. As illustrated in FIG. 1, machine learning engine 100 includes input/output module 120, data preprocessing module 122, model selection module 124, training module 126, evaluation and tuning module 128, and inference module 130.

In accordance with an embodiment, input/output module 120 serves as the primary interface for data entering and exiting the system, managing the flow and integrity of data. This module may accommodate a wide range of data sources and formats to facilitate integration and communication within the machine learning architecture.

In an embodiment, an input handler within input/output module 120 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 120 to be versatile in different operational contexts, whether processing historical datasets or streaming data.

In accordance with an embodiment, input/output module 120 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 120 includes an output framework designed to handle the distribution and exportation of outputs, predictions, or insights. Using the output framework, input/output module 120 formats these outputs into user-friendly and accessible formats, such as reports, visualizations, or data files compatible with other systems. Input/output module 120 also ensures secure and efficient transmission of these outputs to end-users or other systems in an embodiment and may employ encryption and secure data transfer protocols to maintain data confidentiality.

In accordance with an embodiment, data preprocessing module 122 transforms data into a format suitable for use by other modules in machine learning engine 100. For example, data preprocessing module 122 may transform raw data into a normalized or standardized format suitable for training machine learning models and for processing new data inputs for inference. In an embodiment, data preprocessing module 122 acts as a bridge between the raw data sources and the analytical capabilities of machine learning engine 100.

In an embodiment, data preprocessing module 122 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 122 may be configured to handle anomalies in different ways depending on context. Data preprocessing module 122 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 122 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 122 processes new data for inference, data preprocessing module 122 replicates the same preprocessing steps to ensure consistency with the training data format. This helps to avoid discrepancies between the training data format and the inference data format, thereby reducing the likelihood of inaccurate or invalid model predictions.

In an embodiment, model selection module 124 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 124 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 124 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 124 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 124 also considers computational efficiency and resource constraints. This is meant to help ensure the selected model is both accurate and practical in terms of computational and time requirements. In an embodiment, certain features of model selection module 124 are configurable such as a configured bias toward (or against) computational efficiency.

In accordance with an embodiment, training module 126 manages the ‘learning’ process of machine learning models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 126 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 126 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 126 includes logic to handle different types of data and learning tasks. For instance, it includes different training routines for supervised learning (where the training data comes with labels) and unsupervised learning (without labeled data). In the case of deep learning models, training module 126 also manages the complexities of training neural networks that include initializing network weights, choosing activation functions, and setting up neural network layers.

In an embodiment, evaluation and tuning module 128 incorporates dynamic feedback mechanisms and facilitates continuous model evolution to help ensure the system's relevance and accuracy as the data landscape changes. Evaluation and tuning module 128 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 128 performs continuous model tuning by using hyperparameter optimization. Evaluation and tuning module 128 performs an exploration of the hyperparameter space using algorithms, such as grid search, random search, or more sophisticated methods like Bayesian optimization. Evaluation and tuning module 128 uses these algorithms to iteratively adjust and refine the model's hyperparameters-settings that govern the model's learning process but are not directly learned from the data-to enhance the model's performance. This tuning process helps to balance the model's complexity with its ability to generalize and attempts to avoid the pitfalls of underfitting or overfitting.

In an embodiment, evaluation and tuning module 128 integrates data feedback and updates the model. Evaluation and tuning module 128 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 128 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 128 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 130 transforms data raw data into actionable, precise, and contextually relevant predictions. In addition to processing and applying a trained model to new data, inference module 130 may also include post-processing logic that refines the raw outputs of the model into meaningful insights.

In an embodiment, inference module 130 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 130 transforms the outputs of a trained model into definitive classifications. Inference module 130 employs the underlying model as a tool to generate probabilistic outputs for each potential class. It then engages in an interpretative process to convert these probabilities into concrete class labels.

In an embodiment, when inference module 130 receives the probabilistic outputs from the model, it analyzes these probabilities to determine how they are distributed across some or every potential class. If the highest probability is not significantly greater than the others, inference module 130 may determine that there is ambiguity or interpret this as a lack of confidence displayed by the model.

In an embodiment, inference module 130 uses thresholding techniques for applications where making a definitive decision based on the highest probability might not suffice due to the critical nature of the decision. In such cases, inference module 130 assesses if the highest probability surpasses a certain confidence threshold that is predetermined based on the specific requirements of the application. If the probabilities do not meet this threshold, inference module 130 may flag the result as uncertain or defer the decision to a human expert. Inference module 130 dynamically adjusts the decision thresholds based on the sensitivity and specificity requirements of the application, subject to calibration for balancing the trade-offs between false positives and false negatives.

In accordance with an embodiment, inference module 130 contextualizes the probability distribution against the backdrop of the specific application. This involves a comparative analysis, especially in instances where multiple classes have similar probability scores, to deduce the most plausible classification. In an embodiment, inference module 130 may incorporate additional decision-making rules or contextual information to guide this analysis, ensuring that the classification aligns with the practical and contextual nuances of the application.

In regression models, where the outputs are continuous values, inference module 130 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 130 incorporates domain-specific adjustments into its post-processing routine. This involves tailoring the model's output to align with specific industry knowledge or contextual information. For example, in financial forecasting, inference module 130 may adjust predictions based on current market trends, economic indicators, or recent significant events, ensuring that the outputs are both statistically accurate and practically relevant.

In an embodiment, inference module 130 includes logic to handle uncertainty and ambiguity in the model's predictions. In cases where inference module 130 outputs a measure of uncertainty, such as in Bayesian inference models, inference module 130 interprets these uncertainty measures by converting probabilistic distributions or confidence intervals into a format that can be easily understood and acted upon. This provides users with both a prediction and an insight into the confidence level of that prediction. In an embodiment, inference module 130 includes mechanisms for involving human oversight or integrating the instance into a feedback loop for subsequent analysis and model refinement.

In an embodiment, inference module 130 formats the final predictions for end-user consumption. Predictions are converted into visualizations, user-friendly reports, or interactive interfaces. In some systems, like recommendation engines, inference module 130 also integrates feedback mechanisms, where user responses to the predictions are used to continually refine and improve the model, creating a dynamic, self-improving system.

FIG. 2 illustrates the operation of a machine learning engine in one or more embodiments. At step 201, input/output module 120 receives a dataset intended for training. This data can originate from diverse sources, like databases or real-time data streams, and in varied formats, such as CSV, JSON, or XML. Input/output module 120 assesses and validates the data, ensuring its integrity by checking for consistency, data ranges, and types.

At step 202, training data is passed to data preprocessing module 122. Here, the data undergoes a series of transformations to standardize and clean it, making it suitable for training machine learning models. This involves normalizing numerical data, encoding categorical variables, and handling missing values through techniques like imputation.

At step 203, prepared data from the data preprocessing module 122 is then fed into model selection module 124. This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

At step 204, training module 126 trains the selected model with the prepared dataset. It implements learning algorithms to adjust the model's internal parameters, optimizing them to identify patterns and relationships in the training data. Training module 126 also addresses the challenge of overfitting by implementing techniques, like regularization and early stopping, ensuring the model's generalizability.

At step 205, evaluation and tuning module 128 evaluates the trained model's performance using the validation dataset. Evaluation and tuning module 128 applies various metrics to assess predictive accuracy and generalization capabilities. It then tunes the model by adjusting hyperparameters, and if needed, incorporates feedback from the model's initial deployments, retraining the model with new data patterns identified from the feedback.

At step 206, input/output module 120 receives a dataset intended for inference. Input/output module 120 assesses and validates the data.

At step 207, data preprocessing module 122 receives the validated dataset intended for inference. Data preprocessing module 122 ensures that the data format used in training is replicated for the new inference data, maintaining consistency and accuracy for the model's predictions.

At step 208, inference module 130 processes the new data set intended for inference, using the trained and tuned model. It applies the model to this data, generating raw probabilistic outputs for predictions. Inference module 130 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 140 allows for applications to leverage machine learning engine 100. In an embodiment, machine learning engine API 140 may be built on a RESTful architecture and offer stateless interactions over standard HTTP/HTTPS protocols. Machine learning engine API 140 may feature a variety of endpoints, each tailored to a specific function within machine learning engine 100. In an embodiment, endpoints such as /submitData facilitate the submission of new data for processing, while /retrieveResults is designed for fetching the outcomes of data analysis or model predictions. The MLE API may also include endpoints like /updateModel for model modifications and /trainModel to initiate training with new datasets.

In an embodiment, machine learning engine API 140 is equipped to support SOAP-based interactions. This extension involves defining a WSDL (Web Services Description Language) document that outlines the API's operations and the structure of request and response messages. In an embodiment, machine learning engine API 140 supports various data formats and communication styles. In an embodiment, machine learning engine API 140 endpoints may handle requests in JSON format or any other suitable format. For example, machine learning engine API 140 may process XML, and it may also be engineered to handle more compact and efficient data formats, such as Protocol Buffers or Avro, for use in bandwidth-limited scenarios.

In an embodiment, machine learning engine API 140 is designed to integrate WebSocket technology for applications necessitating real-time data processing and immediate feedback. This integration enables a continuous, bi-directional communication channel for a dynamic and interactive data exchange between the application and machine learning engine 100.

### 3. LARGE LANGUAGE MODELS

One type of machine learning model is a large language model. These models are designed to understand, generate, and interpret human language by processing extensive collections of data. The foundational architecture behind large language models is the transformer network, a type of neural network that excels in handling sequential data such as text. Unlike previous architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head self-attention mechanism and a position-wise feed-forward network. Within the architecture of transformer models, the multi-head self-attention mechanism and position-wise feed-forward network function in concert to process input data. The multi-head self-attention mechanism is designed to enable parallel processing of input sequences, allowing the model to simultaneously evaluate the importance of different segments of the input relative to each other. This mechanism operates by generating multiple sets of query, key, and value vectors for elements in the input sequence through linear transformation. The relevance of an element to other elements is calculated using a scaled dot-product attention function. The scaled dot-product attention function computes the attention scores by taking the dot product of the query vector with the key vectors, dividing each dot product by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head self-attention mechanism is the position-wise feed-forward network. This component comprises two linear transformations with a non-linear activation function in between. The elements of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 120 handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 122 in the context of large language models may include steps such as normalization, where the text is converted to a uniform case, and punctuation is standardized. This process ensures that the model treats similar words or symbols consistently, reducing the complexity of the input space. Additionally, techniques, such as sentence segmentation, may be applied to manage longer texts, enabling the model to process information in chunks that align with natural language structures.

In accordance with one or more embodiments, model selection module 124, when used for large language models, involves choosing a specific architecture and configuration that is best suited to the task at hand. This decision is based on several factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 126, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware, such as GPUs (Graphics Processing Units) or TPUs (Tensor Processing Units), to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 128 assesses the performance of large language models using metrics, such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 130 in the context of large language models is responsible for generating predictions or responses based on new, unseen data. This process involves feeding the input data through the trained model to produce an output. Inference can be used for a variety of applications, including translating text, generating human-like responses in a chatbot, or summarizing articles.

### 4. HYPERPARAMETERS

### A. Pre-Training Hyperparameters

In accordance with one or more embodiments, hyperparameters may be set prior to the commencement of the training process and throughout the training process. These hyperparameters are known as pre-training hyperparameters. Pre-training hyperparameters are not directly learned from the data during training. Unlike parameters, which refer to the internal configuration variables of a model that are learned from the data during training, Pre-training hyperparameters are the externally set configurations that dictate the structure and learning process of the model. Pre-training hyperparameters help to govern the behavior of the training algorithm and the architecture of the model itself. The process of hyperparameter tuning in the training phase involves adjusting these parameters to find the configuration that yields the best performance on a given task.

One common hyperparameter is the learning rate that determines the size of the steps that the training algorithm takes during optimization. A high learning rate might cause the model to converge quickly, but it risks overshooting the minimum of the loss function, while a low learning rate might lead to slow convergence, increasing training time.

Batch size is another hyperparameter, specifying the number of training samples to be processed before the model's internal parameters are updated. Smaller batch sizes can lead to a higher degree of stochasticity, potentially aiding the model in escaping local minima, but smaller batch sizes may also increase the variability of the parameter updates and extend training time. Conversely, larger batch sizes provide more stable updates but require more memory and may converge to less optimal solutions.

In accordance with one or more embodiments, the architecture of a neural network may be defined by several hyperparameters, including the number of layers, the number of units in each layer, and the activation functions used. These parameters determine the capacity of the model to learn from the data with more complex models having a higher capacity and a greater risk of overfitting.

Regularization techniques, such as L1 and L2 regularization, include hyperparameters that control the extent of regularization applied during training. These techniques add a penalty to the loss function based on the magnitude of the model parameters, encouraging the model to learn simpler, more generalizable patterns in the data.

Dropout rate is a hyperparameter associated with dropout regularization, a technique used to prevent overfitting by randomly setting a fraction of the input units to 0 at each update during training. The dropout rate determines the likelihood that any given unit is dropped.

The number of epochs, or complete passes through the training dataset, is also a hyperparameter. Training for too many epochs can lead to overfitting, as the model begins to learn noise in the training data, while training for too few epochs might result in an underfit model that has not fully learned the relevant patterns in the data.

Optimization algorithms, such as Stochastic Gradient Descent (SGD), Adam, and RMSprop, have their own sets of hyperparameters. For SGD, momentum and the decay rate are hyperparameters that influence the velocity of the updates and how quickly the learning rate decreases, respectively.

### B. Inference-Time Hyperparameters

In accordance with one or more embodiments, after a machine learning model, such as a large language model, has been trained and its parameters have been “locked” or “frozen” (e.g., the model's weights are no longer updated or adjusted), there are still hyperparameters that can be manipulated to influence the model's performance during inference, known as inference-time hyperparameters. In an embodiment, inference-time hyperparameters do not alter the underlying model architecture or its learned weights; instead, they may be used to adjust the certain aspects of how the model generates predictions or processes input data. The adjustment of inference-time hyperparameters is manual, relying on trial and error to identify settings that optimize performance for specific tasks or datasets. Some inference-time hyperparameters may also be used for training.

In accordance with one or more embodiments, one such inference-time hyperparameter is the “temperature” used in the sampling process for text generation tasks. The temperature controls the randomness in the prediction process, with lower values making the model more likely to choose high-probability words and higher values encouraging more diversity in the generated text. Adjusting the temperature allows operators to balance between the creativity and the predictability of the generated text without modifying the underlying model.

In accordance with one or more embodiments, another inference-time hyperparameter is the “top-k” sampling parameter that restricts the model's choice of next words to the k most likely options. This can prevent the model from making implausible or unrelated word choices, thus improving the coherence of the generated text. Similarly, “top-p” or “nucleus” sampling parameters limit the next word choices to a cumulative probability mass, further focusing the model's predictions. Top-p sampling addresses some of the limitations inherent in top-k sampling by dynamically selecting the smallest set of words with a cumulative probability that exceeds the threshold p. Instead of limiting the model to a fixed number of k most probable words, top-p sampling considers the actual probability distribution of the next word predictions and is restricted to including words that collectively sum up to a specified probability mass p. This approach allows for a more flexible and context-sensitive selection of words, as the size of the set can vary depending on the certainty of the model's predictions.

In addition to temperature, top-k, and top-p sampling strategies, there are other inference-time hyperparameters and configurations that can be adjusted post-training to fine-tune a frozen large language model's output during inference in one or more embodiments. One such hyperparameter is the “length penalty,” used in tasks where generating longer sequences is necessary such as in document summarization. The length penalty adjusts the model's preference for longer or shorter sequences, allowing operators to encourage the generation of outputs that meet specific length requirements without altering the trained model parameters. This helps operators achieve a desired verbosity or succinctness.

In accordance with one or more embodiments, another inference-time hyperparameter is the “early stopping” criterion that determines if the model should cease generating further tokens once it has produced a token indicating the end of a sequence (e.g., a period for sentences or a special end-of-text token). This mechanism prevents the model from adding irrelevant or repetitive content after a logical conclusion has been reached, enhancing the relevance and coherence of the output.

In accordance with one or more embodiments, the “minimum length” inference-time hyperparameter sets a lower bound on the length of generated sequences, ensuring that the model produces outputs of at least a certain size. This is particularly useful in scenarios where responses that are too brief might be considered incomplete or insufficient, such as in automated customer support or content creation applications. By imposing a minimum length, operators can ensure that the model's outputs meet minimum content requirements, providing more informative and engaging responses.

In accordance with one or more embodiments, “beam search width” is an inference-time hyperparameter relevant for models performing tasks, such as translation or summarization, whose goal is to find the most likely sequence of words. By controlling the number of sequences considered at each step, operators can influence the trade-off between inference time and the quality of the generated output.

In accordance with one or more embodiments, applying hyperparameters at inference time does not alter the foundational, learned parameters within the model's architecture established through the training phase. The parameters learned during the training phase remain intact and unmodified. The role of inference-time hyperparameters is to fine-tune the operational dynamics through which the model interacts with input data to generate output without impacting the underlying model structure or its trained weights. For example, a large language model may be trained to generate text. Once training is complete, the weights and biases that constitute the model's knowledge base (i.e., the learned parameters) are fixed. When the model is deployed for inference, a hyperparameter, such as temperature, may be introduced to influence text generation, but the use of the temperature hyperparameter during inference does not result in retraining the model or altering the model's internal knowledge. Instead, using the temperature hyperparameter during inference is like adjusting a lever that affects how the model's fixed knowledge is applied to generate output. If the temperature is set low, the model's knowledge is applied conservatively, favoring more predictable, high-probability words. If the temperature is increased, the model's application of knowledge becomes more exploratory, choosing a broader array of words, including those less probable.

The configuration of inference-time hyperparameters requires a nuanced understanding of how the hyperparameters impact model performance, often requiring extensive experimentation. Operators may adjust these settings based on empirical observations of model output, aiming to optimize for different factors, such as fluency, coherence, or novelty in the generated text. This process is inherently iterative, with the potential for significant variability in outcomes based on the chosen hyperparameter values.

In accordance with one or more embodiments, hyperparameters allow for significant flexibility in tailoring model outputs to specific requirements, but optimal settings for inference-time hyperparameters are often task-dependent and require empirical tuning. The process of adjusting inference-time hyperparameters may involve monitoring the model's performance on validation datasets or through assessment of output samples to find a balance that best meets the goals of the specific application. In addition, the interaction between different hyperparameters can introduce complexity into the tuning process. For example, adjusting the temperature parameter to increase creativity may necessitate changes to top-k or top-p settings to maintain coherence. Similarly, applying a length penalty might affect the choice of early stopping criteria or minimum length settings, as operators seek to balance the generation of adequately lengthy responses with the need to avoid verbosity.

### 5. INFERENCE-TIME HYPERPARAMETER TUNING ARCHITECTURE

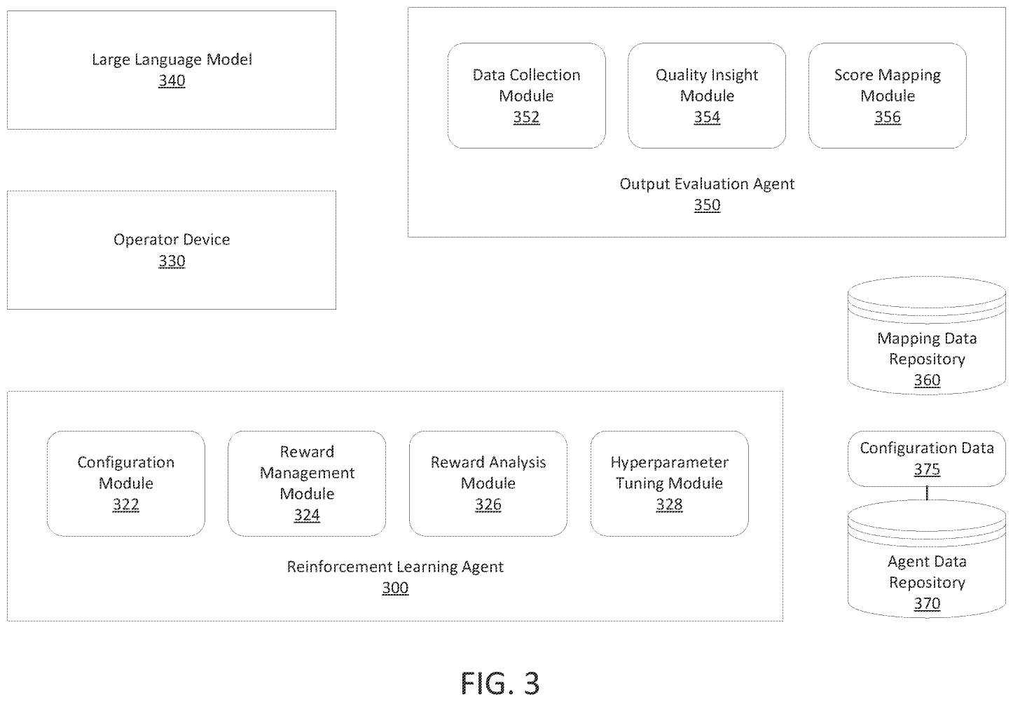

FIG. 3 illustrates a system in accordance with one or more embodiments. FIG. 3 includes reinforcement learning agent 300, operator device 330, large language model 340, output evaluation module 350, mapping data repository 360, and agent data repository 370. Reinforcement learning agent 300 includes configuration module 322, reward management module 324, reward analysis module 326, and hyperparameter tuning module 328. Output evaluation agent 350 includes data collection module 352, quality insight module 324, and score mapping module 356. In one or more embodiments, the system illustrated in FIG. 3 may include more or fewer components than the components illustrated in FIG. 3. The components illustrated in FIG. 3 may be local to or remote from each other. The components illustrated in FIG. 3 may be implemented in software and/or hardware. Components may be distributed over multiple applications and/or machines. Multiple components may be combined into one application and/or machine. Operations described with respect to one component may instead be performed by another component.

In accordance with one or more embodiments, operator device 330 is representative of a device used to make requests to large language model 340 for predictions. Operator device may include input/output logic, a user interface, hardware for network connectivity, and an operating system in an embodiment. Operator device is configured to generate requests to (and receive responses from) large language model 340.

In accordance with one or more embodiments, large language model 340 is representative of a large language model as described in Section 2. Large language model 340 is a trained model requiring no further training. Large language model 340 is configured to receive requests from other devices that may include parameters for adjusting hyperparameters. For example, large language model 340 may receive inference-time hyperparameter adjustments from reinforcement learning agent 300 and may use the adjustments when generating a response to a query sent from operator device 330.

In accordance with one or more embodiments, configuration module 322 serves as a setup mechanism for reinforcement learning agent 300, establishing the operational parameters and environment within which reinforcement learning agent 300 functions. These parameters and other configuration data 375 may be stored in agent data repository 370 in an embodiment. Reinforcement learning agent 300 may be configured to operate within a cloud computing environment or virtualized network. Configuration module 322 is configured to initialize the reinforcement learning agent 300's structural components, including defining the state and action spaces that delineate the scope of possible interactions between reinforcement learning agent 300 and its environment. It specifies the dimensions and types of states (e.g., continuous, discrete) and actions (e.g., vector actions for continuous control, categorical actions for discrete choices) that the agent can engage with, ensuring compatibility with the complexity and nature of the tasks it is designed to solve.

In accordance with one or more embodiments, configuration module 322 is responsible for integrating the reinforcement learning agent with external systems such as output evaluation agent 350. This integration enables reinforcement learning agent 300 to receive external quality scores that serve as feedback for assessing the consequences of actions taken within the environment. The configuration module ensures that the interface between reinforcement learning agent 300 and output evaluation agent 350 is correctly established, facilitating a flow of information.

In accordance with one or more embodiments, interactions between configuration module 322 and other components of reinforcement learning agent 300, such as reward management module 324, reward analysis module 326, and hyperparameter tuning module 328, are defined through interfaces that allow for the exchange of information and commands. Although configuration module 322 may not directly manage the dynamic aspects of learning and adaptation, configuration module 322 serves to guide how these processes are executed. For example, configuration module 322 may specify the architecture and initial weights for neural networks used in the policy and value functions that are then refined by hyperparameter tuning module 328 based on feedback analyzed by reward analysis module 326 and collected by reward management module 324.

In accordance with one or more embodiments, reward management module 324 is configured to collect, store, and preliminary process reward data derived from reinforcement learning agent 300's environment interactions. Reward management module 324 is configured to capture the rewards returned after each action taken by the reinforcement learning agent 300. Reward management module 324 records these rewards, along with associated metadata, including state and action information, into a structured format within agent data repository 370.

In accordance with one or more embodiments, in addition to accumulating immediate reward data, reward management module 324 is configured to compute cumulative rewards for sequences of actions, applying discounting where necessary to account for the time value of rewards. The discount factor, configured by the configuration module, is applied to future rewards to calculate their present value, enabling the agent to weigh immediate rewards against future gains.

In accordance with one or more embodiments, reward management module 324 supplies reward analysis module 326 and hyperparameter tuning module 328 with the data to be used for the analysis of actions' effectiveness and the subsequent optimization of policy and parameters for reinforcement learning agent 300. Reward analysis module 326 relies in part on the detailed reward data collected by reward management module 324 to perform in-depth analyses on the impact of specific actions or sequences of actions. It uses this data to identify patterns, trends, and correlations that can inform the strategy development and refinement.

In accordance with one or more embodiments, the reward data maintained by reward management module 324 enables hyperparameter tuning module 328 to apply informed adjustments to the hyperparameters for large language model 340. By determining the relationship between specific hyperparameter settings and observed rewards, hyperparameter tuning module 328 can iteratively optimize these settings to enhance the output of large language model 340.

In accordance with an embodiment, agent data repository 370 acts as a bridge between the experiential outcomes of the agent's actions and the analytical processes that guide its evolution and adaptation. Agent data repository 370 serves as a ledger of the agent's experiential learning, documenting the outcomes of its decisions across various states and actions over time. Agent data repository 370 is any type of storage unit and/or device (e.g., a file system, database, collection of tables, or any other storage mechanism) for storing data. Further, a agent data repository 370 may include multiple different storage units and/or devices. The multiple different storage units and/or devices may or may not be of the same type or located at the same physical site. Further, a agent data repository 370 may be implemented or executed on the same computing system as reinforcement learning agent 300. Additionally, or alternatively, agent data repository 370 may be implemented or executed on a computing system separate from reinforcement learning agent 300. Agent data repository 370 may be communicatively coupled to reinforcement learning agent 300 via a direct connection or via a network.

In accordance with one or more embodiments, reward analysis module 326 is configured to dissect and interpret the complex relationships between the agent's actions, hyperparameter settings for large language model 340, and the resulting performance as measured by rewards. Reward analysis module 326 is configured to leverage reward data collected and stored by reward management module 324 to examine different actions and strategies that influence success in achieving the objectives reinforcement learning agent 300. Reward analysis module 326 evaluates the outcome of hyperparameter changes made by hyperparameter tuning module 328, identifying those that lead to higher rewards and those that do not.

In accordance with one or more embodiments, reward analysis module 326 is configured to assess the advantage of actions taken in specific states. By comparing the actual rewards received to the expected rewards based on the current policy or value estimations, reward analysis module 326 identifies the relative value of different actions. This analysis may result in a calculation of temporal difference errors and may use techniques, such as generalized advantage estimation, to enable reward analysis module 326 to estimate the future benefits of actions with greater accuracy.

In accordance with one or more embodiments, reward analysis module 326 interacts with hyperparameter tuning module 328, supplying hyperparameter tuning module 328 with insights derived from the analyses performed by reward analysis module 326. Based on the findings of reward analysis module 326, the hyperparameter tuning module 328 can make informed decisions about adjusting the hyperparameters for large language model 340 to improve performance. This collaboration ensures that hyperparameter adjustments are data-driven and grounded in evidence of what works well and what does not.

In accordance with one or more embodiments, hyperparameter tuning module 328 is configured to perform adjustments of inference-time hyperparameters for large language model 340 to optimize performance. Hyperparameter tuning module 328 employs optimization algorithms to refine the settings of various parameters, including learning rates, exploration rates, and policy parameters, based on feedback from interactions with its environment. Hyperparameter tuning module is configured to identify the parameter configurations that maximize the cumulative rewards obtained by the agent.

In accordance with one or more embodiments, output evaluation agent 350 is configured to track and, in some cases, automate the assessment of quality in responses generated by large language model 340. Output evaluation agent 350 provides quantitative feedback on the effectiveness and relevance of these responses. Through its integrated modules for data collection, score mapping, and quality insight, the agent gathers and analyzes output data to generate quality scores.

In accordance with one or more embodiments, data collection module 352 is communicatively coupled with large language model 340 to capture output and associated feedback. Data collection module 352 is configured to retrieve input queries, feedback, responses to input queries, and metadata that may include timestamps, response length, and other relevant data points. Data collection module 352 supports batch and real-time data collection modes that enable asynchronous processing of outputs for efficiency. The architecture incorporates error handling mechanisms to manage rate limits or failures, ensuring data integrity and continuity in data collection operations.

In accordance with one or more embodiments, data collection module 352 includes a data normalization sub-component used to standardize the collected data into a unified format suitable for analysis and storage. This data normalization sub-component uses a series of preprocessing functions to clean and structure the raw output and feedback data, facilitating compatibility with downstream agents and modules.

In accordance with one or more embodiments, score mapping module 356 is configured to establish and maintain a relational database structure that links input queries, language model outputs, and the generated quality scores. This module utilizes database mapping data repository 360 to store, query, and manage large volumes of data. The architecture supports complex queries to correlate inputs, outputs, and scores, enabling detailed analysis and reporting capabilities.

In accordance with one or more embodiments, score mapping module 356 includes an indexing strategy optimized for fast retrieval of records based on various dimensions, such as query text, output quality scores, or feedback categories. This facilitates rapid access to data for real-time analysis and the dynamic adjustment of quality evaluation parameters. The module is designed with extensibility in mind, allowing for future enhancements, such as the incorporation of machine learning models, to predict quality scores based on historical data patterns.

In accordance with one or more embodiments, quality insight module 354 is configured to compute quality scores for the large language model outputs using a set of predefined metrics and algorithms. In an embodiment, quality insight module 354 integrates analytical tools and machine learning models trained on datasets of previously evaluated outputs to assess new outputs. In an embodiment, the architecture supports modular analytics components responsible for evaluating different aspects of output quality, such as coherence, relevance, and factual accuracy. These components output individual metric scores that are then aggregated into a composite quality score using a weighted algorithm.

To ensure adaptability, quality insight module 354 includes a configuration interface that allows operators to adjust the weighting of different quality metrics and update or replace the machine learning models used for evaluation. In an embodiment, quality insight module 354 incorporates a mechanism to leverage ratings from human input, integrating these evaluations with its assessments to generate quality scores. By capturing and analyzing human feedback on the quality of language model outputs, quality insight module 354 may enrich quality scores with nuanced insights that automated metrics might overlook.

In an embodiment, the models, devices, agents, repositories, and modules described with respect to FIG. 3 may be implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 6. TUNING HYPERPARAMETERS

In an embodiment, reinforcement learning agent 300 includes a computational framework designed for optimizing a set of hyperparameters for large language model 320 to maximize one or more quality metrics received from output evaluation agent 324. In an embodiment, reinforcement learning agent 300 optimizes a set of hyperparameters using few-shot reinforcement learning techniques. Reinforcement learning agent 300 first undergoes training on a variety of tasks to build a versatile base of skills and get good at adapting. When faced with a new task, it uses meta-learning to adjust its existing knowledge based on a few examples, essentially fine-tuning its strategy by using what it previously learned to determine what to do next. Finally, it applies transfer learning to modify its pre-learned skills specifically for the new task, relying on internal simulations to anticipate outcomes and refine its approach with minimal real-world interactions. This allows reinforcement learning engine 300 to guess the results of its actions without trying a large number of possible actions reinforcement learning engine 300 can take.

In accordance with one or more embodiments, an operator initiates the process by setting initial values for these hyperparameters, or a default set of hyperparameters may be configured. These initial values serve as a starting point for the exploration of the hyperparameter space. The optimization process iterates through cycles of evaluation. A cycle includes modifying one or more of the hyperparameters slightly, using large language model 340 with these new hyperparameters, and measuring the resulting quality metric. The objective of these iterations is to identify the configuration of hyperparameters that results in an acceptable or optimal value of the quality metric, as configured.

During each iteration, reinforcement learning agent 300 adjusts the hyperparameters based on the feedback received from the previous iteration's outcome. This feedback loop informs the direction and magnitude of the next set of hyperparameter modifications. To ensure that these modifications do not lead to volatile jumps in the hyperparameter space, potentially resulting in suboptimal performance or instability in the output quality metric, the process incorporates a mechanism for constraining the magnitude of hyperparameter changes. This mechanism, called clipping, functions by setting bounds on the rate hyperparameters can be altered, independent of any other constraints configured by an operator. By setting bounds on the rate of change, reinforcement learning agent 300 mitigates the risk of making overly aggressive adjustments that could move the hyperparameters too far from regions of known good performance.

In accordance with one or more embodiments, as the process iterates, reward analysis module 324 adjusts the hyperparameters, informed by incorporating an underlying model that predicts the relationship between hyperparameter changes and resulting performance variations. This model, discussed further below, can be based on gradient estimation or other predictive techniques and assists in determining the most effective direction to adjust the hyperparameters to improve the quality metric. Through successive iterations, this model is refined as more data is collected from the evaluations, enabling a more accurate prediction of the impact of hyperparameter changes.

In accordance with one or more embodiments, the iterative process continues until a predefined convergence criterion is met. In an embodiment, the criterion may be based on a minimal threshold for improvement in the quality metric, indicating that further adjustments are unlikely to result in significant performance gains. In another embodiment, the criterion could be based on reaching a maximum number of iterations. Upon nearing convergence, the process may shift into a phase of more granular optimization, where hyperparameter adjustments are made with finer precision to ensure that the optimal configuration is as closely approximated as possible.

During the optimization process, reinforcement learning agent 300 explores the hyperparameter space. This exploration is driven by the interactions reinforcement learning agent 300 has with a simulated environment, where each set of hyperparameters represents a distinct state within that environment. The agent's actions correspond to adjustments in these hyperparameters, and the feedback (reward) received after an action informs the reinforcement learning agent 300 about the effectiveness of the adjustments. In an embodiment, the reward may be a function of the quality metric or set of quality metrics that the reinforcement learning agent 300 aims to maximize or minimize. Through this mechanism, the agent learns that hyperparameter adjustments led to improvements in the quality score(s).

In accordance with one or more embodiments, reinforcement learning agent 300 employs a policy. This policy is a probabilistic model that maps states (hyperparameter configurations) to actions (adjustments) to navigate the hyperparameter space. Initially, this policy may be exploratory, focusing on gathering information about the hyperparameter space rather than focusing on precision and optimal adjustments. As the reinforcement learning agent 300 accumulates reward data, including state-action-reward tuples, it uses this information to update its policy. This update process may be implemented through algorithms, such as Q-learning (focuses on learning the optimal action-value function to derive a policy), or direct policy optimization methods, like policy gradient algorithms such as Proximal Policy Optimization (PPO). The update process then incrementally refines the approach towards selecting actions that more reliably lead to higher rewards.

In accordance with one or more embodiments, reinforcement learning agent 300 refines the policy using a balance between exploration and exploitation. Exploration involves trying new or less frequently chosen actions to discover potential for improving the quality score(s). This helps to prevent the optimization from converging prematurely to hyperparameter values that may be optimal within a neighboring set of values but not necessarily the best overall solution. Exploitation, on the other hand, leverages accumulated knowledge to choose actions that are known to yield high rewards. Reinforcement learning agent 300 dynamically balances these two aspects, gradually shifting from exploration to exploitation as the reinforcement learning agent 300 accumulates enough knowledge of the hyperparameter space to meet a confidence threshold. Techniques, such as epsilon-greedy strategies, may be used by reinforcement learning agent 300 to maintain this balance by randomly exploring with probability epsilon and exploiting current knowledge of the hyperparameter space.

Through iterative cycles of exploration, learning, and policy refinement, reinforcement learning agent 300 converges towards a set of hyperparameters that optimize the quality metric. A cycle involves the agent selecting an action based on its current policy, executing the action to adjust the hyperparameters, receiving feedback from the environment in the form of a reward based on the resulting quality metric, and updating its policy based on this new data. This process results in a systematic, data-driven exploration of the hyperparameter space with the agent's policy serving as a continuously evolving strategy for identifying the optimal hyperparameter configuration.

In accordance with one or more embodiments, reinforcement learning agent 300 uses the sequence of generated quality scores in conjunction with a gradient method, such as PPO, to assess the performance impact of recent adjustments to the variables. PPO provides a sophisticated policy update mechanism that leverages advantage estimation to make this possible. This function, known as A(s, a), assesses the relative value of taking a particular action a in a state s over the typical action for that state under the current policy. The advantage function is derived by calculating the difference between the action-value function Q(s, a). The action-value function represents the expected return from taking action a in state s, and the value function V(s), the expected return of being in state s under the current policy. Therefore, the advantage A(s, a) is defined as A(s, a)=Q(s, a)−V(s), signifying the additional or reduced reward achieved by deviating from the policy's average action.

For the efficient calculation of A(s, a), PPO often utilizes Generalized Advantage Estimation (GAE) that relies on the use of Temporal Difference (TD) error calculation. TD errors are a key concept in reinforcement learning that measure the difference between the predicted rewards and the actual outcomes after taking an action in a given state. It calculates this discrepancy by comparing the expected rewards, based on the current policy or value function, against the observed rewards following an action and its outcome. For any state-action pair (s, a) that leads to a new state s′ with reward r, the TD error y is given by the following equation:

δ=r+γV(s′)−V(s)

Here, r is the immediate reward received after taking action a in state s, V(s) is the current estimate of the state's value according to the value function, V(s′) is the estimated value of the next state s′ after taking action a, and γ is the discount factor that balances the importance of future rewards against immediate rewards. The TD error captures the variance between the expected future rewards (as estimated before taking the action) and the combined immediate reward and discounted future rewards (as recalculated after the action and its result are observed). This error signal is utilized to update the agent's value function or policy, aiming to improve its predictions of future rewards and thereby optimizing its decision-making process over time.

GAE combines TD error calculations with an exponentially weighted estimator to reduce variance while managing bias. It suggests that the advantage can be estimated as a sum of exponentially discounted TD errors, facilitating an optimal balance between variance and bias by tweaking the focus on future rewards. This approach improves policy performance while minimizing large shifts from the previous policy to ensure training stability. Optimizing the policy based on these advantage estimates, PPO steers the reinforcement learning agent towards actions expected to enhance overall performance, effectively encouraging the learning of a policy that maximizes cumulative rewards.

In an embodiment, reinforcement learning agent 300 maintains and iteratively refines a policy that dictates the selection of hyperparameter adjustments based on observed states, with the aim of maximizing the quality score(s). Reinforcement learning agent 300 employs a clipped objective function in an embodiment, optimizing the policy in a stable and efficient manner. This function uses the concept of advantage. Advantage measures the relative benefit of taking a specific action compared to the average outcome for that state to guide the optimization. It is computed as the difference between the estimated returns following an action and the value of the state itself, reflecting the improvement or decline in the quality score(s) as a direct result of the most recent set of adjustments. These computations are stored in agent data repository 370 for use during the next iteration and for additional analysis.

In accordance with one or more embodiments, previously generated quality scores may be used to update the estimates of expected returns and state values. The expected returns and state values are then used to calculate the advantage. These updates may be performed using techniques that are influenced by temporal difference methods but are adapted within the PPO framework to support policy optimization. By continuously updating the policy based on advantage estimates, reinforcement learning agent 300 progressively favors actions that lead to higher quality scores. Using the clipping method described earlier, reinforcement learning agent 300 prevents the policy from changing too drastically, thereby mitigating the risk of destabilizing the learning process due to excessively large updates.

In accordance with one or more embodiments, iterative cycles of action selection, performance evaluation, and policy updating using advantage estimates allow reinforcement learning agent 300 to converge on a set of variables that optimize the quality metric until the benefit of further optimization reaches a preconfigured performance threshold. This process may incorporate learning from the history of interactions, leveraging the incremental nature of reinforcement learning to refine the policy in a direction that consistently improves performance.

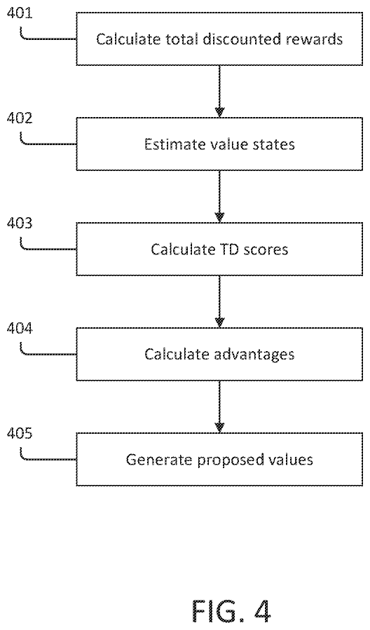

FIG. 4 shows a flow chart that illustrates generating a hyperparameter update recommendations in accordance with one or more embodiments. In particular, FIG. 4 illustrates and example using PPO to generate hyperparameter update recommendations. Initially, reinforcement learning agent 300 calculates the total discounted rewards (Operation 401). Calculating total discounted rewards involves starting from a given state and looking forward to subsequent rewards that reinforcement learning agent 300 is expected to receive. These future rewards are discounted using a factor (γ). This discount reduces the future reward value based on how far in the future they occur. The rationale behind discounting is to reflect the preference for immediate rewards over those that might be received later, a principle grounded in the uncertainty and diminishing value of future outcomes. This calculation aggregates the present value of future rewards from a particular point, providing a measure of the expected return from following the current policy from that state onwards.

In accordance with one or more embodiments, reinforcement learning agent 300 estimates value states using a neural network designed to approximate the expected return from each state under the current policy (Operation 402). This network is trained to predict the total discounted rewards that the agent can expect to accumulate, starting from each state it encounters. The input to the neural network is the representation of a state, and the output is the estimated value of that state. The actual returns are calculated based on the total discounted rewards, taking into account the rewards collected in each episode under the policy being optimized. The neural network approximates the total discounted rewards for each state, providing a method to assess the desirability of states without the need to explicitly calculate the total discounted rewards each time.

In one or more embodiments, reinforcement learning agent 300 calculates TD scores (Operation 403). As discussed above, TD scores represent the Temporal Difference error, quantifying the discrepancy between predicted and actual rewards following an action in a given state. This calculation assesses the difference between two quantities: the sum of the reward received for taking a specific action and the discounted estimated value of the subsequent state, and the estimated value of the current state. Thus, TD scores provide a direct measure of the error in our predictions.

In one or more embodiments, reinforcement learning agent 300 calculates advantages (Operation 404). As discussed above, the advantage calculation measures the relative benefit of taking a specific action (e.g., adjusting a hyperparameter) given the current state. Advantages are calculated in part using the TD score calculated at step 403. By computing advantages, reinforcement learning agent 300 assesses the efficacy of actions beyond reward accumulation, focusing on how each action improves over the expectation under current conditions.

In one or more embodiments, reinforcement learning agent 300 generates proposed values (or adjustments) for inference-time hyperparameters based in part on the calculated advantages (Operation 405). This involves using the advantage estimates to guide the selection of optimal hyperparameter adjustments that maximize the performance of large language model 340. Reinforcement learning agent 300 attempts to find adjustments that are expected to yield higher returns (e.g., quality scores) as indicated by the advantage function without deviating too drastically from the current policy to ensure stability in learning. This balance is maintained by employing techniques such as the PPO clipping mechanism. The PPO clipping mechanism prevents overly large changes by using boundaries that limit the magnitude of change.

In accordance with one or more embodiments, reinforcement learning agent 300 may use Q-learning instead of gradient methods, such as PPO, to evaluate the performance impact on the quality score(s). In such cases, the evaluation of the performance impact from the latest set of variable adjustments is conducted through the calculation and application of the TD error within the Q-value update rule. Although Q-learning uses a TD error, it is calculated differently because it specifically aims to learn the optimal policy indirectly by updating the Q-values. The Q-values represent the expected utility of taking a given action in a given state and then following the optimal policy. In Q-learning, the TD error incorporates the difference between the current Q-value and the maximum Q-value for the next state, discounted by the factor y and added to the immediate reward. This calculation reflects Q-learning's off-policy nature, allowing it to estimate the value of the best possible future action at each step, irrespective of the current policy's suggested action. This approach enables the algorithm to continuously refine its Q-values toward the optimal action-value function, effectively guiding the agent's decisions toward maximizing long-term rewards.

The TD error is derived as the discrepancy between the predicted and the actual rewards following an action in a given state under the current policy. Specifically, the TD error is derived from the difference between the estimated future rewards and the observed rewards. For a given state-action pair (s,a) leading to a new state s′ with an immediate reward r, the Q-learning formula for the TD error is as follows:

δ=r+γmaxₐ·Q(s′,a′)−Q(s,a)

Here, r is the reward received after taking action a in state s, γ is the discount factor, maxₐ·Q (s′,a′) represents the maximum estimated future reward achievable from the new state s′. This maximization is key to the off-policy nature of Q-learning, where the algorithm estimates the value of the optimal policy regardless of the followed policy. Q(s,a) is the current estimate of the Q-value for the state-action pair. The TD error δ then guides the update of the Q-value towards a better approximation of the true optimal Q-value. This error quantifies the adjustment needed to align the current Q-value with the newly observed reward plus the best estimated future rewards, effectively guiding the update process to refine the Q-value towards a more accurate representation of the expected total reward.

Upon the execution of an action in a given state, reinforcement learning agent 300 observes the immediate reward. The immediate reward is a direct reflection of the outcome of the variable changes. The Q-value for the specific state-action pair, representing the expected cumulative future reward, is then updated according to the TD error. The TD error is calculated as the difference between the observed reward plus the discounted maximum future reward from the next state (as estimated by the current Q-values) and the current Q-value for the state-action pair.

In accordance with one or more embodiments, reinforcement learning agent 300 adjusts the Q-value by a fraction of the TD error, scaled by a learning rate hyperparameter, ensuring that the Q-value moves closer to the newly observed estimate of its true value. Through this process, the updated Q-value integrates the latest performance feedback, directly linking the impact of the recent variable adjustments to the agent's future decision-making framework.

The iterative application of this update mechanism across encountered state-action pairs allows reinforcement learning agent 300 to refine its Q-values towards more accurate estimations of the expected rewards for taking certain actions in specific states. Consequently, the Q-learning algorithm incrementally guides the agent towards a policy that favors actions yielding higher rewards based on the cumulative learning from each update, directly utilizing the feedback from the quality scores generated by the recent adjustments to the variables.

In accordance with one or more embodiments, instead of analyzing multiple hyperparameters concurrently, reinforcement learning agent 300 may evaluate the differential impact of single hyperparameter adjustments on a defined performance metric. This approach entails a systematic alteration of individual hyperparameters within a comprehensive set, monitoring the resultant variation in the quality metric to deduce the hyperparameter's contribution to overall performance. By incrementally modifying one hyperparameter while maintaining others at their baseline levels, reinforcement learning agent 300 isolates the effect of specific hyperparameter changes, facilitating a nuanced understanding of the hyperparameter space dynamics.

In an embodiment, the iterative process for evaluating the impact of a single hyperparameter involves selecting a hyperparameter, applying a perturbation, executing the policy or action derived from the current state, and observing the consequent change in the reward or quality metric. This data informs the reward analysis module 326 by adjusting Q-values in value-based methods or by optimizing policy hyperparameters in policy gradient methods to incrementally refine the model towards optimal performance. The sequential exploration of individual hyperparameter impacts enables reinforcement learning agent 300 to construct a high-resolution map of the hyperparameter-performance landscape, identifying hyperparameters with significant leverage on the quality metric.

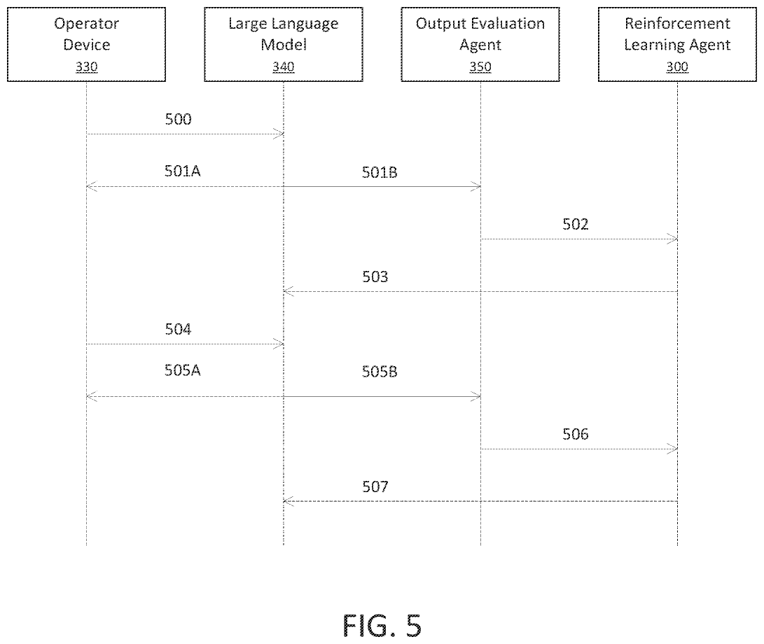

FIG. 5 illustrates an example set of operations for tuning inference-time hyperparameters in accordance with one or more embodiments. One or more operations illustrated in FIG. 5 may be modified, rearranged, or omitted. Accordingly, the particular sequence of operations illustrated in FIG. 2 should not be construed as limiting the scope of one or more embodiments.

In an embodiment, an operator device initiates a request to a large language model (Operation 500). The request may include, for example, an input query for information retrieval, a prompt for creative content generation, or a complex question requiring detailed explanation. The request may also include feedback about a response to the query immediately preceding the current query, indicating the quality of the response. The request may be provided to the large language model via a user interface, API, or any other mechanism that interfaces with the large language model.

Upon receiving the request, the large language model processes the input, applying its pre-trained algorithms and knowledge base to generate a response. The large language model also considers any adjustments made to inference-time hyperparameters when generating a response. This response is then returned to the operator device (Operation 501A).

In accordance with an embodiment, the large language model also provides the request and associated data to an output evaluation agent (Operation 501B). The purpose of sharing the request to the output evaluation agent is to determine if the request implies or indicates a quality associated with a previous interaction. For example, the immediately preceding request may have been related to a question about European history, resulting in a response from the large language model. If the next request sent from the operator device to the large language model begins with the words “no, that's not what I meant,” then the output evaluation agent may determine that the response previously generated by the large language model was unsatisfactory.

In an embodiment, the output evaluation agent generates a quality score that indicates the quality of the response previously generated by the large language model. The output evaluation agent uses analytical tools and machine learning models trained on datasets of previously evaluated outputs to assess new outputs. In an embodiment, the evaluation of the output takes into consideration human ratings, computational methods, or other output evaluation mechanisms to generate a quality score. The output evaluation agent then sends the quality score to a reinforcement learning agent (Operation 502).

In accordance with one or more embodiments, the reinforcement learning agent uses the quality score to evaluate the impact of changes previously made to inference-time hyperparameters. For example, if a prior adjustment to the temperature hyperparameter resulted in a decreased quality score, the reinforcement learning agent may determine that another adjustment should be made to the temperature hyperparameter. The reinforcement learning agent may evaluate any combination of inference-time hyperparameters in this way in an embodiment, leading to one or more value adjustment calculations for one or more hyperparameters. The reinforcement learning agent uses PPO, Q-learning, or other mechanisms previously described to determine a set of desired hyperparameter adjustments. The reinforcement learning agent then configures the large language model with the hyperparameter adjustments (Operation 503).

The process is iterative. In accordance with one or more embodiments, the operator device makes another request to the large language model (Operation 504). As with Operation 500, the request may include an input query for information retrieval, a prompt for creative content generation, or a complex question; the request may also include feedback about the response to the query in Operation 501A.

Upon receiving the request, the large language model processes the input, considering the previously made hyperparameter adjustments, and generates a response. This response is then returned to the operator device (Operation 505A). The large language model also provides the request and associated data to the output evaluation agent (Operation 505B).

In an embodiment, the output evaluation agent generates a quality score that indicates the quality of the response generated by the large language model and returned to the operator device at Operation 501A. The output evaluation agent then sends the quality score to a reinforcement learning agent (Operation 506).

In accordance with one or more embodiments, the reinforcement learning agent uses the quality score to evaluate the impact of changes previously made to inference-time hyperparameters during Operation 503. The reinforcement learning agent then uses the mechanisms previously described to determine a set of desired hyperparameter adjustments. The reinforcement learning agent then configures the large language model with the hyperparameter adjustments (Operation 507).

In accordance with one or more embodiments, the process illustrated in FIG. 5 may continue to iterate until a performance threshold is met, indicating that continued iterations are not expected to result in a benefit that justifies the resources required to obtain a better-quality score. For example, in PPO, the advantage score discussed above, denoted as A (s,a) for a given state s and action a, measures how much better it is to take a particular action compared to the average action in that state under the current policy. In this case, the advantage score can be used to measure how much better it would be to make another change to one or more inference-time hyperparameters. If a pre-configured threshold for the advantage score is not met for an action selected as the preferred action by the reinforcement learning agent, then the process may discontinue, as the system has reached the desired state.

### 7. EXAMPLE EMBODIMENT

A detailed example is described below for purposes of clarity. Components and/or operations described below should be understood as one specific example that may not be applicable to certain embodiments. Accordingly, components and/or operations described below should not be construed as limiting the scope of any of the claims.

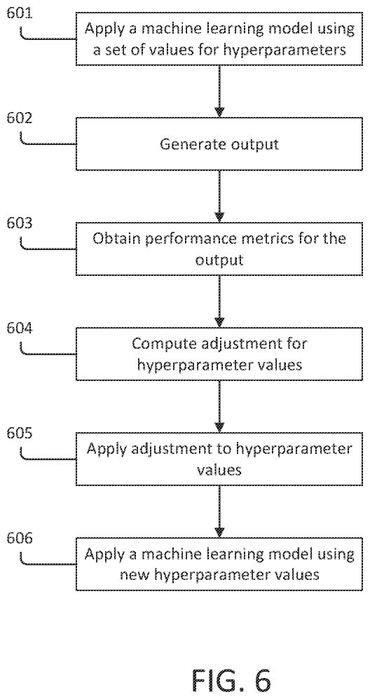

FIG. 6 shows a flow chart that illustrates an example embodiment. A machine learning model is applied using a set of values for a set of hyperparameters (Operation 601). For example, a large language model may be applied to input text. Although the large language model is “frozen,” a set of inference-time hyperparameters such as temperature, top-P, and top-K may be assigned values to influence the output of the large language model at inference time.

Next, the large language model generates output (Operation 602) based on the input text and the values provided for inference-time hyperparameters. The model processes this input, applying learned patterns and structures from its training data to construct a coherent and contextually relevant output.

At step 603, a reinforcement learning agent obtains performance metrics for the output. For example, a second input text may be provided to the large language model as a follow-up to the output generated at step 602. To further illustrate this step, if the initial input text was “tell me about hydrofoil boats”, and the output was related to motor-powered hydrofoil boats, a follow-up input may be “I mean hydrofoil sailboats.” This response may be used as a performance indicator showing that the output may not have been the desired or expected output. Performance metrics, such as quality scores associated with hyperparameters, may be generated and provided to the reinforcement learning agent.

At step 604, the reinforcement learning agent computes an adjustment for hyperparameter values. For example, based on the performance metrics provided in the previous step, the reinforcement learning agent may evaluate any combination of inference-time hyperparameters to generate value adjustments for one or more hyperparameters. The reinforcement learning agent uses PPO, Q-learning, or other mechanisms previously described to determine a set of desired hyperparameter adjustments for the inference-time hyperparameters.

At step 605, the reinforcement learning agent applies the calculated adjustment to the inference-time hyperparameters. For example, the reinforcement learning agent may connect directly to the large language model and communicate the desired adjustments. In another embodiment, the adjustments may be communicated to a client being used by an operator to provide input to the large language model. At step 606, the machine learning model is applied to new input using the new hyperparameter values.

### 8. EXTENSIONS AND ALTERNATIVES

In accordance with an embodiment, the process may iterate, meaning that new input may represent additional feedback from the operator. Additional performance metrics may be calculated and used by the reinforcement learning agent to generate additional adjustments for inference-time hyperparameters.

In accordance with an embodiment, the same large language model may be used by multiple operator devices. Operator devices may use the large language model in a different context, potentially benefiting from using or changing different sets of inference-time hyperparameters. For example, one operator device may not configure top-K as an adjustable option, resulting in no value adjustments for the top-K hyperparameter even though an adjustment would be made if the option were presented to the reinforcement learning agent. In another embodiment, the large language model may be configured to ignore certain adjustments.

In accordance with an embodiment, an operator may influence the impact of the reinforcement learning agent value changes through configuration of either the reinforcement learning agent or the large language model. For example, an operator may set a hyperparameter value to a default value, null value, or a particular value chosen by the operator. The operator may also adjust the weight of the hyperparameter to reduce impact, masking the hyperparameter to ensure that no instructions relating to that hyperparameter are provided to the large language model. These settings may be configured at the reinforcement learning agent or the large language model via a user interface or an API.

In accordance with one or more embodiments, configurable settings may allow an operator to enable or disable “assistance” for one or more hyperparameters. For example, an operator may indicate via a flag or other configuration setting that assistance should be provided for the top-K hyperparameter and the temperature hyperparameter. An indication that assistance should be provided for a hyperparameter may be interpreted by either the large language model or the reinforcement learning agent to indicate that value adjustments for the selected hyperparameters should be generated by the reinforcement learning agent and applied by the large language model. In the example above, the settings would cause the value adjustments generated by the reinforcement learning agent to be applied to the top-K hyperparameter and the temperature hyperparameter but not to other hyperparameters. In an embodiment, the default configuration may indicate that assistance should be provided for hyperparameters. In another embodiment, the default configuration may indicate that no assistance should be provided for any hyperparameters. In an embodiment, an operator may indicate that certain hyperparameters are non-adjustable, while others are adjustable. As a result, values for non-adjustable hyperparameters may not be changed, while values for adjustable hyperparameters may be changed if an adjustment for that hyperparameter is determined to be desirable by the reinforcement learning agent.

In accordance with one or more embodiments, configurable settings may allow for more nuanced settings. For example, an operator may indicate freezing one or more hyperparameter values within a range. This means that the operator policy applied via the configuration will allow for adjustments to be made based on adjustment calculations made by the reinforcement learning agent. For example, the reinforcement learning agent may determine that a hyperparameter value with a range of 0 to 1 that is currently set to 0.5 should be adjusted with an increase of 0.1, resulting in a value of 0.6 after the adjustment. If the range specified in the configuration for the hyperparameter is 0.3 to 0.7, the adjustment to 0.6 will be allowed. However, if additional adjustments are made, eventually with an adjustment calculation that would result in a value of 0.8 for the hyperparameter, the proposed adjustment may be either rejected altogether or clipped to the closest acceptable value (in this case, 0.7). Like the other settings, this may be configured at either the reinforcement learning agent, the large language model, or the client if the client is responsible for sending the hyperparameter values to the large language model.

In accordance with one or more embodiments, a reinforcement learning agent may be used to compare large language models with one another. For example, the reinforcement learning agent may be configured to treat a model identifier as a hyperparameter. The same input may be presented to two separate models, and the output of the models may be analyzed by an output evaluation agent to generate a quality score. A series of changes may be made to the hyperparameter values for each model to converge on an optimal set of hyperparameter values for each model. Alternatively, the same hyperparameter values may be used for each model. The use of one model may result in a much higher quality score than another model, resulting in the selection of that model.

In accordance with an embodiment, the reinforcement learning agent may select a less effective model (e.g., the one with lower quality scores) based on a configuration. For example, the reinforcement learning agent may consider metrics associated with each model when selecting a model. The reinforcement learning agent may also consider additional preferences and settings. To illustrate further, a reinforcement learning agent may be configured to select a model based on factors, like resource usage, cost, quality, and other metrics. These preferences may result in the selection of a model that may have output with consistently lower quality output but with dramatically lower costs due to resource usage.

In an embodiment, such preferences may be configured as priorities with bounds placed on each metric. If none of the available models can provide output of the minimum configured quality for the maximum configured price, then the reinforcement learning agent may generate a response to the operator device in an embodiment. If multiple models can provide output of the minimum configured quality for the maximum configured price, then the reinforcement learning agent may either select a model based on a configured prioritization or may be selected in response to an operator preference or default setting. In another embodiment, the operator may manually select a preferred model from a list of choices.

### 9. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 10. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

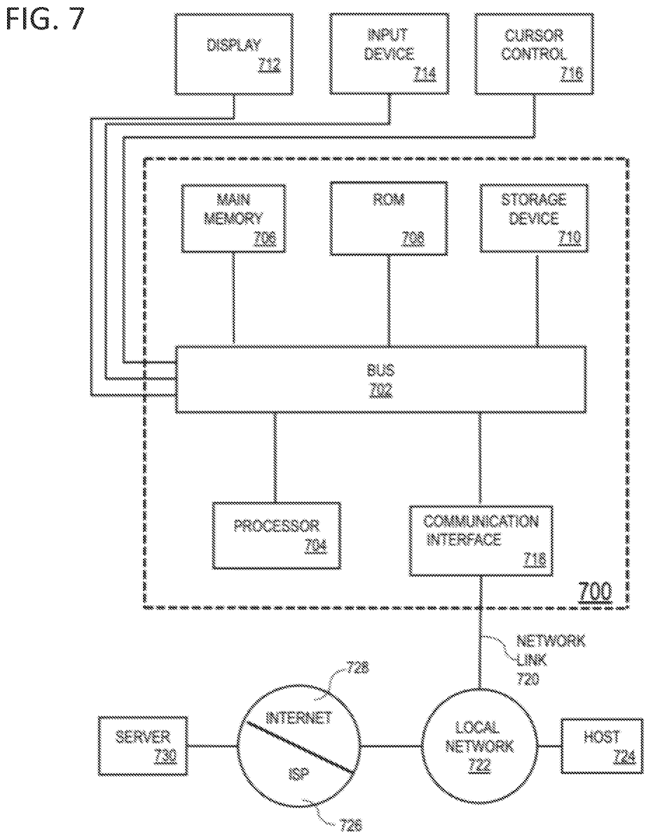

For example, FIG. 7 is a block diagram that illustrates a computer system 700 upon which an embodiment of the disclosure may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or a Solid State Drive (SSD) is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

### 11. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
applying a first machine learning model, with a first set of values for a first set of hyperparameters, to a first set of input to generate a first output;
obtaining a first set of performance metrics corresponding to the first output;
based at least on the first set of performance metrics, computing a first adjustment for the first set of values for the first set of hyperparameters, the first adjustment comprising modifying at least one value of the first set of values;
applying the first adjustment to the first set of values for the first set of hyperparameters to generate a second set of values for the first set of hyperparameters;
applying the first machine learning model, with the second set of values for the first set of hyperparameters, to a second set of input.

2. The one or more non-transitory media of claim 1, wherein the operations further comprise:
obtaining a second set of performance metrics corresponding to a second output generated by the application of the first machine learning model to the second set of input;
determining a performance effect of the first adjustment based at least in part on first set of performance metrics and the second set of performance metrics;
computing a second adjustment for the second set of values for the first set of hyperparameters based at least in part on the performance effect of the first adjustment;
applying the second adjustment to the second set of values for the first set of hyperparameters to generate a third set of values for the first set of hyperparameters;
configuring the first machine learning model with the second set of values for the first set of hyperparameters;
applying the first machine learning model, with the third set of hyperparameters, to a third set of input to generate a third output.

3. The one or more non-transitory media of claim 1, wherein the operations further comprise:
applying the first machine learning model, with a third set of values for a second set of hyperparameters, to a third set of input to generate a second output;
obtaining a second set of performance metrics corresponding to the second output;
based at least on the second set of performance metrics, computing a second adjustment for the third set of values for the second set of hyperparameters, the second adjustment comprising an increase or decrease to at least one value of the third set of values;
applying the second adjustment to the third set of values for the second set of hyperparameters to generate a fourth set of values for the second set of hyperparameters;
applying the first machine learning model, with the fourth set of values for the second set of hyperparameters, to a fourth set of input.

4. The one or more non-transitory media of claim 1, wherein applying the first adjustment to the first set of values for the first set of hyperparameters comprises removing an effect of a hyperparameter of the first set of hyperparameters at least by one of:
a) setting the value of a hyperparameter to a default value;
b) setting the value of a hyperparameter to a null value;
c) adjusting the weight of a hyperparameter; or
d) masking the hyperparameter.

5. The one or more non-transitory media of claim 1, wherein the operations further comprise:
in response at least in part to receiving a user instruction to adjust a value of a hyperparameter, adjusting a value of the second set of values for a hyperparameter of the first set of hyperparameters.

6. The one or more non-transitory media of claim 1, wherein computing the first adjustment for the first set of values for the first set of hyperparameters comprises:
in response at least in part to interpreting configuration data to determine that a first hyperparameter of the first set of hyperparameters is configured to be adjustable, computing an adjustment for the value for the first hyperparameter.

7. The one or more non-transitory media of claim 1, wherein computing the first adjustment for the first set of values for the first set of hyperparameters comprises:
in response at least in part to interpreting a configuration to determine that a first value for a first hyperparameter of the first set of hyperparameters is configured to be non-adjustable, retaining the first value for the first hyperparameter; and
in response at least in part to interpreting a configuration to determine that a second value for a second hyperparameter of the first set of hyperparameters is configured to be adjustable, computing an adjustment for the second value for the second hyperparameter.

8. The one or more non-transitory media of claim 1, wherein computing the first adjustment for the first set of values for the first set of hyperparameters comprises:
in response at least in part to interpreting a configuration to determine that a first hyperparameter of the first set of hyperparameters is configured to satisfy a value-restricting condition:
computing a value that does not satisfy the value-restricting condition for the first hyperparameter of the first set of hyperparameters;
adjusting the first value to generate a value that does satisfy the value-restricting condition, wherein the second value is in the first set of values;
in response at least in part to interpreting a configuration to determine that a third value for a second hyperparameter of the first set of hyperparameters is adjustable, computing an adjustment for the second value for the second hyperparameter;
including the second value and the third value in the first adjustment.

9. The one or more non-transitory media of claim 8, wherein computing the first adjustment for the first set of values for the first set of hyperparameters comprises:
in response at least in part to interpreting a configuration to determine that a fourth value for a third hyperparameter of the first set of hyperparameters is configured to be non-adjustable, retaining the fourth value for the third hyperparameter.

10. The one or more non-transitory media of claim 1, wherein the operations further comprise:
based at least in part on the application of the first machine learning model to the second set of input, generating a second output;
applying a second machine learning model, with the second set of values for the first set of hyperparameters, to the second set of input to generate a third output;
obtaining a second set of performance metrics corresponding to the second output;
obtaining a third set of performance metrics corresponding to the third output;
generating a model value score based at least on:
a) the second set of performance metrics;
b) the third set of performance metrics;
c) a resource usage metric associated with the first machine learning model; and
d) a resource usage metric associated with the second machine learning model.

11. A method comprising:
applying a first machine learning model, with a first set of values for a first set of hyperparameters, to a first set of input to generate a first output;
obtaining a first set of performance metrics corresponding to the first output;
based at least on the first set of performance metrics, computing a first adjustment for the first set of values for the first set of hyperparameters, the first adjustment comprising modifying at least one value of the first set of values;
applying the first adjustment to the first set of values for the first set of hyperparameters to generate a second set of values for the first set of hyperparameters;
applying the first machine learning model, with the second set of values for the first set of hyperparameters, to a second set of input;
wherein the method is performed by at least one device including a hardware processor.

12. The method of claim 11, further comprising:
obtaining a second set of performance metrics corresponding to a second output generated by the application of the first machine learning model to the second set of input;
determining a performance effect of the first adjustment based at least in part on first set of performance metrics and the second set of performance metrics;
computing a second adjustment for the second set of values for the first set of hyperparameters based at least in part on the performance effect of the first adjustment;
applying the second adjustment to the second set of values for the first set of hyperparameters to generate a third set of values for the first set of hyperparameters;
configuring the first machine learning model with the second set of values for the first set of hyperparameters;
applying the first machine learning model, with the third set of hyperparameters, to a third set of input to generate a third output.

13. The method of claim 11, further comprising:
applying the first machine learning model, with a third set of values for a second set of hyperparameters, to a third set of input to generate a second output;
obtaining a second set of performance metrics corresponding to the second output;
based at least on the second set of performance metrics, computing a second adjustment for the third set of values for the second set of hyperparameters, the second adjustment comprising an increase or decrease to at least one value of the third set of values;
applying the second adjustment to the third set of values for the second set of hyperparameters to generate a fourth set of values for the second set of hyperparameters;
applying the first machine learning model, with the fourth set of values for the second set of hyperparameters, to a fourth set of input.

14. The method of claim 11, wherein applying the first adjustment to the first set of values for the first set of hyperparameters comprises removing an effect of a hyperparameter of the first set of hyperparameters at least by one of:
a) setting the value of a hyperparameter to a default value;
b) setting the value of a hyperparameter to a null value;
c) adjusting the weight of a hyperparameter; or
d) masking the hyperparameter.

15. The method of claim 11, further comprising:
in response at least in part to receiving a user instruction to adjust a value of a hyperparameter, adjusting a value of the second set of values for a hyperparameter of the first set of hyperparameters.

16. The method of claim 11, wherein computing the first adjustment for the first set of values for the first set of hyperparameters comprises:
in response at least in part to interpreting a configuration to determine that a first hyperparameter of the first set of hyperparameters is configured to be adjustable, computing an adjustment for the value for the first hyperparameter.

17. The method of claim 11, wherein computing the first adjustment for the first set of values for the first set of hyperparameters comprises:
in response at least in part to interpreting a configuration to determine that a first value for a first hyperparameter of the first set of hyperparameters is configured to be non-adjustable, retaining the first value for the first hyperparameter; and
in response at least in part to interpreting a configuration to determine that a second value for a second hyperparameter of the first set of hyperparameters is configured to be adjustable, computing an adjustment for the second value for the second hyperparameter.

18. The method of claim 11, wherein computing the first adjustment for the first set of values for the first set of hyperparameters comprises:
in response at least in part to interpreting a configuration to determine that a first hyperparameter of the first set of hyperparameters is configured to be value-restricted to a first set of values:
computing a first value for the first hyperparameter of the first set of hyperparameters;
adjusting the first value to generate a second value, wherein the second value is in the first set of values;
in response at least in part to interpreting a configuration to determine that a third value for a second hyperparameter of the first set of hyperparameters is adjustable, computing an adjustment for the second value for the second hyperparameter;
including the second value and the third value in the first adjustment.

19. The method of claim 11, further comprising:
based at least in part on the application of the first machine learning model to the second set of input, generating a second output;
applying a second machine learning model, with the second set of values for the first set of hyperparameters, to the second set of input to generate a third output;
obtaining a second set of performance metrics corresponding to the second output;
obtaining a third set of performance metrics corresponding to the third output;
generating a model value score based at least on:
a) the second set of performance metrics;
b) the third set of performance metrics;
c) a resource usage metric associated with the first machine learning model; and
d) a resource usage metric associated with the second machine learning model.

20. A system comprising:
at least one device including a hardware processor;
the system being configured to perform operations comprising:
applying a first machine learning model, with a first set of values for a first set of hyperparameters, to a first set of input to generate a first output;
obtaining a first set of performance metrics corresponding to the first output;
based at least on the first set of performance metrics, computing a first adjustment for the first set of values for the first set of hyperparameters, the first adjustment comprising modifying at least one value of the first set of values;
applying the first adjustment to the first set of values for the first set of hyperparameters to generate a second set of values for the first set of hyperparameters;
applying the first machine learning model, with the second set of values for the first set of hyperparameters, to a second set of input.
